(19) United States
(12) Patent Application Publication
(10) Pub. No.: US 2023/0014378 A1
(43) Pub. Date: Jan. 19, 2023

(54) ELECTRIC VEHICLE MOBILE CHARGING STATION AND METHOD OF DELIVERY

(71) Applicants: Thomas Ciesco, Northford, CT (US); Joel Douglas, Bonita Springs, FL (US); Shem Lachhman, Ponce, PR (US)

(72) Inventors: Thomas Ciesco, Northford, CT (US); Joel Douglas, Bonita Springs, FL (US); Shem Lachhman, Ponce, PR (US)

(21) Appl. No.: 17/866,447

(22) Filed: Jul. 15, 2022

Related U.S. Application Data
(60) Provisional application No. 63/222,189, filed on Jul. 15, 2021.

(51) Int. Cl. B60L 53/66; B60L 53/57; B60L 53/52; B60L 53/51; B60L 58/16; B60L 58/24; G06Q 30/02

(52) U.S. Cl. CPC B60L 53/665; B60L 53/51; B60L 53/52; B60L 53/57; B60L 58/16; B60L 58/24; G06Q 30/0226

(57) ABSTRACT

A mobile charging station for a high voltage electric vehicle including a mobile vehicle for transporting charging apparatus. The charging apparatus includes an electric energy source for providing electricity, a circuit for converting the energy source electricity to a specific voltage range required by the electric vehicle to be charged and at least one connector engageable with a charging connector on the electric vehicle to be charged. The mobile charging station may be driven to the location of the electric vehicle. A vehicle charge may be initiated by a communication sent from a cellular device or a mobile communication device. The mobile charging station may include a remote command center capable of receiving communication from a consumer and remotely initiating a service call to the consumer or an automatic battery health and safety check system to ensure the battery is not leaking, or over heated to prevent vehicle fire.

### CROSS-REFERENCE TO RELATED APPLICATIONS

This application claims the benefit of U.S. Provisional Pat. Application No. 63/222,189 filed on Jul. 15, 2021, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The invention relates to the field of electric vehicle chargers and more specifically, charging systems which are mobile and may be scheduled by a user on a phone or computer app.

### Description of Related Art

Consumers owning or leasing an electric vehicle would welcome a service of having someone come and charge their car instead of having to drive to a station and wait for a charging station or waiting for the vehicle to charge and would be willing to pay a monthly or yearly subscription service to have that done on a routine basis. Emergency charging requests may also be a source for providing charging services.

In particular there is a need for a solution to at least one of the aforementioned problems. For instance, there is In particular there is a need for a solution to at least one of the aforementioned problems. For instance, there is a need for a mobile system that can utilize a variety of charging devices to recharge electric vehicles.

### BRIEF SUMMARY OF THE INVENTION

The instant invention in one form is directed to Quick charge technology including charging using 110V, 220V, 440V or other voltage sources may be included in the mobile charging station. The charging station may include a circuit for transferring the energy from batteries in the mobile charging station to the vehicle being charged, without having to substantially step up or step down the voltage, making the process more efficient. The batteries or energy source in the mobile charging station may be layered or stacked such that they may be tapped at different voltages, again, making the energy transfer more efficient.

The charging station may include multiple battery banks to provide the ability to charge multiple vehicles before the charging station needs to be replenished, a fossil fuel based generator or a solar charging system. When using batteries to replenishing the charging station the process may include driving the charging station delivery vehicle back to a central location for charging. Replenishing the charging station may include driving the charging station delivery vehicle to a commercial or local charging station to charge the mobile charging station energy source, similar or identical to charging the consumer electric vehicle.

A charging station delivery vehicle may be an electric vehicle or may include an internal combustion engine for providing power to move the vehicle and/or power to recharge the charging station batteries. Alternately the internal combustion engine may run a generator to directly charge the electric vehicle.

Automatic service may be provided for charging during the day or at a specified time period.

Some electric vehicles cannot be charged when they are locked so a system may be used for generating a signal to unlock the vehicle may be provided. Most electric vehicles can be remotely unlocked.

An app may be provided for consumers to request service, pay and communicate with the mobile charging station or command center. Billing may be automatic or a integrated payment kiosk could be incorporated into the charging vehicle.

The mobile charging station may be transported by a van which may have an eye catching exterior and advertisement information (a color such as purple) to give name recognition to the service.

Dealerships may provide short or long term quick charge services in their contract when a customer buys a new electric car.

A mobile app for requesting or scheduling charging services may be associated with the mobile charging station directly or may communicate with a command center to dispatch a mobile charging station. The app may be used for scheduling, payment, review, or access to a client database.

A network of mobile charging stations described herein may be franchised.

In a first implementation of the invention, a mobile charging station for an electric vehicle includes a mobile vehicle for transporting charging apparatus. The charging apparatus includes an electric energy source for providing electricity, a circuit for converting the energy source electricity to a specific voltage range required by the electric vehicle to be charged and at least one connector engageable with a charging connector on the electric vehicle to be charged. The mobile charging station may be driven to the location of the electric vehicle. A vehicle charge may be initiated by a communication sent from a cellular device or a mobile communication device. The mobile charging station may include a remote command center capable of receiving communication from a consumer and remotely initiating a service call to the consumer. The mobile charging station may include an automatic battery health and safety check system to ensure the battery is not leaking, or over heated to prevent vehicle fire. The mobile charging station may include an automated generator shut off to prevent overload. The mobile charging station may include a temperature monitoring and control system for warning driver of battery issue. The mobile charging station may include a perks program to earn wattage of charge for your vehicle if the service is used via the smart phone app. The app may have the ability to automatically schedule consecutive charges to the vehicle with auto-pays. The mobile charging station may include a payment program to 3rd party operators, which pays an operator to go to a home and charge a vehicle via the smart phone app wherein the operator is paid on a per charge or time taken to charge basis with the equipment.

Another aspect of the present invention is directed to a mobile electric vehicle charging network comprising a plurality of mobile charging stations, each charging station including a mobile vehicle for transporting charging apparatus. The charging apparatus includes an electric energy source for providing electricity, a circuit for converting the energy source electricity to a specific voltage range required by the electric vehicle to be charged and at least one connector engageable with a charging connector on the electric vehicle to be charged. The charging network has a command center capable of carrying out any of the following steps: a) receiving and sending communication requesting charging service; locating a customer vehicle requiring a charge; b) sending a communication to at least one of the mobile charging stations including information on the customer vehicle location; c) if needed, providing a signal for unlocking customer vehicle; d) taking orders from a mobile app and if needed, communicating the information to at least one of the mobile charging stations; and e) ensuring payment has been made.

Another aspect of the present invention is directed to a method of using a mobile electric vehicle charging network comprising providing a plurality of mobile charging stations, each charging station including a mobile vehicle for transporting charging apparatus. The charging apparatus includes an electric energy source for providing electricity, a circuit for converting the energy source electricity to a specific voltage range required by the electric vehicle to be charged and at least one connector engageable with a charging connector on the electric vehicle to be charged. The method includes providing a command center in communication with the plurality of mobile charging stations and receiving a communication requesting charging service; locating a vehicle requiring a charge. The method includes calculating which mobile charging station to send to a customer requesting service or for a customer having a scheduled charge and sending a communication to the mobile charging station chosen in the previous step, including information on the electric vehicle location. The method may include if needed, providing a signal for unlocking the electric vehicle; and charging the electric vehicle.

Another aspect of the present invention is directed to a method of using a mobile electric vehicle charging station comprising providing a charging station including a mobile vehicle for transporting charging apparatus having an electric energy source for providing electricity, a circuit for converting the energy source electricity to a specific voltage range required by the electric vehicle to be charged and at least one connector engageable with a charging connector on the electric vehicle to be charged. The method includes receiving a communication requesting charging service, locating a vehicle requiring a charge and if needed, providing a signal for unlocking the electric vehicle. The method includes charging the electric vehicle.

The mobile charging station may include a perks program to earn wattage of charge for your vehicle if the service is used via the smart phone app the program including the ability to automatically schedule consecutive charges to the vehicle with auto-pays.

The mobile charging station may include a payment program to 3rd party operators, which pays an operator to go to a home and charge a vehicle via the smart phone app. The operator is paid on a per charge or time taken to charge basis with the equipment.

The mobile charging station may include a clean energy harvester attachment to the roof of a transport vehicle for consistently charging the battery to preserve on fuel to power a generator and charge an electric vehicle, the clean energy harvester able to harvest energy from wind passing over the vehicle during driving or the sun.

Another aspect of the present invention is directed to a remote charging device for an electric vehicle comprising a separate vehicle, the separate vehicle comprising an electrical generator, a motor mechanically coupled to the electrical generator to operate the generator to produce an electric charge. The separate vehicle includes a fuel tank fluidly connected to the motor, a charging distribution device electrically connected to the generator and a state of charge indicator connected to the charging distribution device. The method of using the remote charging device includes a user connecting the electric vehicle to the charging distribution device and the user starts the motor and the generator to produces an electric charge that charges the electric vehicle. The user stops the motor when the state of charge indicates the desired level of charge.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sublabel, it is intended to refer to all such multiple similar components.

FIG. 1 shows a first embodiment of a mobile charging station 10 for charging a high voltage electric vehicle.

FIG. 2 shows a fleet of mobile charging stations for covering a specific geographical location.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms charging apparatus , generator, battery pack and solar charger are used interchangeably to mean a device capable of charging a electric vehicle battery pack of the instant invention.

The term charging vehicle, charging truck, charging trailer as used in the specification is meant to mean a vehicle equipped with a charging apparatus.

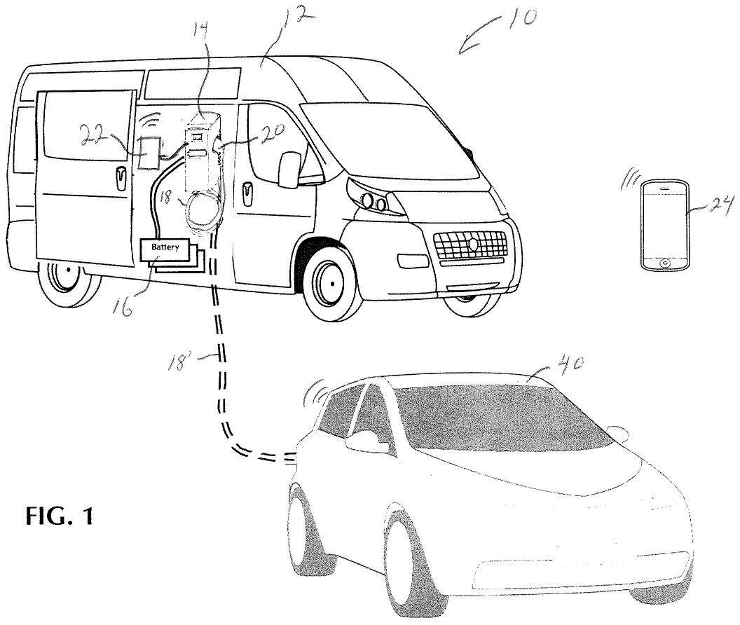

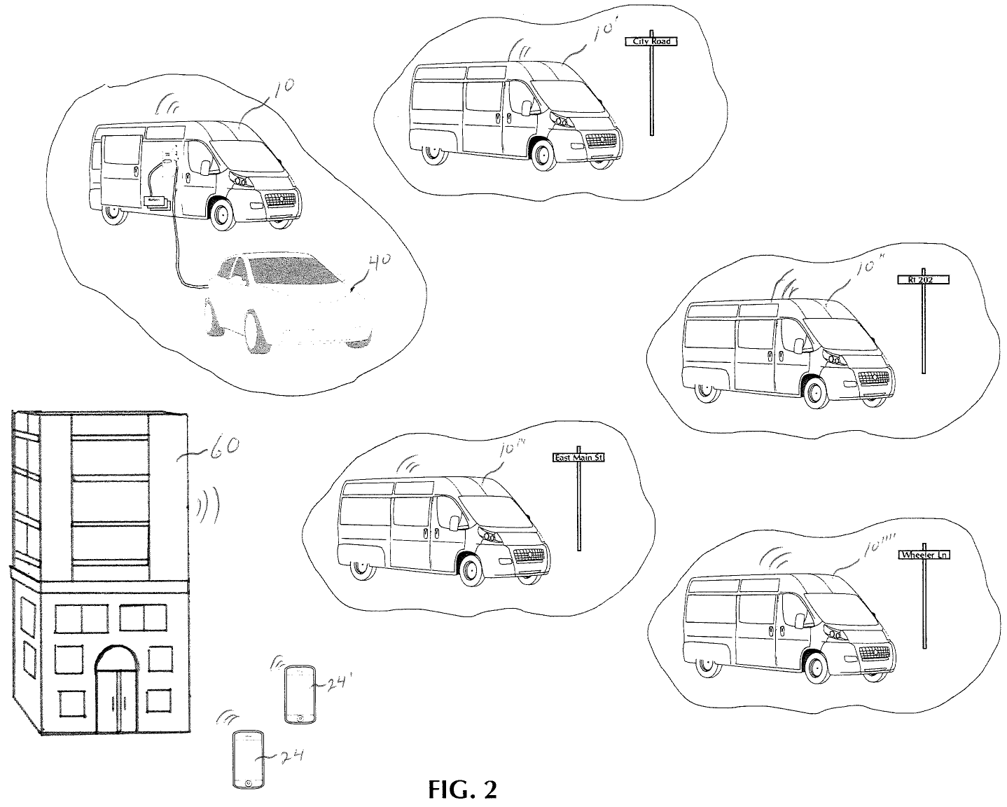

FIG. 1 shows a first embodiment of a mobile charging station 10 for charging a high voltage electric vehicle. The mobile charging station 10 includes a mobile vehicle 12 for transporting the charging apparatus 14. The charging apparatus 14 includes an electric energy source or battery 16 for providing high voltage electricity to the charging apparatus 14. Alternatively battery 16 could be a motor generator set that is capable of supplying a suitable voltage to charge an electric vehicle. In a optional embodiment the charging vehicle could have a number of charged battery packs and provide a replacement service for the battery pack in the electric vehicle being serviced. Reference to high voltage includes voltages about 110 volts -1000 volts and may extend into any range which an electrical vehicle may operate. The mobile charging station 10 includes a cable 18,18' which is extendable from the charging apparatus to a customer’s vehicle 40 which is to be charged. The cable is attached at one end to the charging apparatus and at the opposite end to a supply connector 20. The cable is can be selected from any suitable length and include an optional extension cord if necessary. The supply connector 20 engages the charging port on the customer’s vehicle 40. Alternate supply connectors may be included to provide more voltage and connector options. A control box or control panel 22 controls the output of the charging apparatus 14 and may control charging and control of the electric energy source 16. A wireless device 24 may communicate with the control panel 22 for sending order information to the control panel or to relay the information from another electronic device. Alternately, a command center 60 as shown in FIG. 2 may communicate with the wireless device 24 and/or the control panel 22. The mobile charging station may include a circuit for converting the energy source electricity to a specific voltage range required by the electric vehicle to be charged. The mobile charging station includes at least one supply connector 20 engageable with the charging port or charging connector on the electric vehicle to be charged (customer’s vehicle 40). The mobile charging station may be driven to the location of the customer’s vehicle 40. The mobile charging station can be a vehicle, truck, van or trailer. Optionally, the mobile charging station 10 may be operated by auto-pilot and the mobile charging station may be continually monitored at the command center 60 with a plurality of cameras, Lidar, or other sensors attached internally and externally. The command center 60 may be implemented within one of the mobile charging stations 10. A plurality of command centers 60 may be provided so that each command center 60 would direct the mobile charging stations 10 in a specific area and all of the command centers 60 may be networked or franchised.

In an embodiment where the battery is part of the charging vehicle the battery can be formed from a assembly of typical cylindrical or jelly roll batteries such as 18650 cells or it can be made from a series of cells forming a prismatic battery. Prismatic batteries usually have higher energy densities and therefor will require less space to provide the same amount of energy as an assembly of typical cylindrical or jelly roll batteries.

Preferably the mobile vehicle 12 is an electric vehicle. When the charging apparatus is a battery the mobile vehicle 12 can be a battery source that may be quickly and easily replaced with a freshly charged battery source. Exchange can be made manually or with a transport mechanism.

### Business Method

Develop a fleet of vans or other type of transporting vehicle having a series of lithium batteries or other applicable chemistry, motor generator set or solar charger available for charging electric cars for customers on a routine schedule, special delivery or emergency situations such as when a customer’s electric vehicle has a depleted energy source and does not have sufficient energy to reach their closest charging destination. The vans, including a charging station and battery source, can be used for emergency charges or charging for people who do not want to wait in line for a charging station, or want their cars charged at a destination which does not have a charging station. A customer can subscribe to a monthly or yearly plan or just use it for emergencies. The fleet can be spread out to cover a specific area and either be manne1 or auto pilot. If unmanned, the vans can be strategically placed at rest areas or the like and can be remotely operated to keep overhead low. The vans may supply service to a customer base and be available for emergency charges. As shown in FIG. 2, the fleet may be a plurality of mobile charging stations 10, 10', 10", etc. for covering a specific geographical location. The command center 60 may dispatch any or all of the mobile charging stations as well as schedule routine vehicle charges and accept incoming calls or incoming data from any electronic device or phone, including handheld wireless devices 24, 24' and the like.

### Small Engine Generator

A glaring problem with electric vehicles since their inception in electric vehicle charging and fuel replenishment has been the major drawback with the technology. The early electric vehicles such as Morrison’s electric carriage of 1896 has had range and recharging time issues which have been a major drawback of the technology.

The gasoline power car overcame the range and refueling problems which transformed the more mechanically difficult technology into the prominent vehicle technology of the 20th century.

The problem of refueling the electric car is one that must be overcome to successfully convert the existing fleet of vehicles to electric vehicles.

One subset of this is the problem of emergency refueling and inter-trip refueling.

The instant invention is a solution for emergency refueling and inter-trip refueling by creating a mobile network of refueling vehicles that can recharge stranded or vehicles needing to top off their charge.

Refueling vans with large battery packs that can be used to transfer energy to a vehicle needing fuel.

Refueling van with small propane or compress natural gas-powered generators that can be used to transfer energy to a vehicle needing fuel.

Refueling van with large battery packs that have a small propane or compress natural gas-powered generators that can be used to transfer energy to the battery packs and then the battery packs can transfer energy to a vehicle needing fuel.

The battery pack can be a prismatic battery pack due to the higher energy density of the battery versus a welded cylindrical cell battery design. A prismatic cell is a cell whose chemistry is enclosed in a rigid casing. Its rectangular shape allows efficiently stacking multiple units in a battery module. There are two types of prismatic cells: the electrode sheets inside the casing (anode, separator, cathode) are either stacked or rolled and flattened.

### The Main Differences Between Prismatic and Cylindrical Cells

Shape is not the only thing that differentiates prismatic and cylindrical cells. Other important differences include their size, the number of electrical connections, and their power output.

### Size

Prismatic cells are much larger than cylindrical cells and hence contain more energy per cell. To give a rough idea of the difference, a single prismatic cell can contain the same amount of energy as 20 to 100 cylindrical cells. The smaller size of cylindrical cells means they can be used for applications that require less power. As a result, they are used for a wider range of applications.

### Connections

Because prismatic cells are larger than cylindrical cells, fewer cells are needed to achieve the same amount of energy. This means that for the same volume, batteries that use prismatic cells have fewer electrical connections that need to be welded. This is a major advantage for prismatic cells because there are fewer opportunities for manufacturing defects.

### Power

Cylindrical or jelly roll cells may store less energy than prismatic cells, but they have more power. This means that cylindrical cells can discharge their energy faster than prismatic cells. The reason is that they have more connections per amp-hour (Ah). As a result, cylindrical cells are ideal for high-performance applications whereas prismatic cells are ideal to optimize energy efficiency.

Example of high-performance battery applications include Formula E race cars and the Ingenuity helicopter on Mars. Both require extreme performances in extreme environments.

### Why Prismatic Cells Might Be Taking Over

The EV industry evolves quickly, and it’s uncertain whether prismatic cells or cylindrical cells will prevail. At the moment, cylindrical cells are more widespread in the EV industry, but there are reasons to think prismatic cells will gain in popularity.

First, prismatic cells offer an opportunity to drive down costs by diminishing the number of manufacturing steps. Their format makes it possible to manufacture larger cells, which reduces the number of electrical connections that need to be cleaned and welded.

Prismatic batteries are also the ideal format for the lithium-iron phosphate (LFP) chemistry, a mix of materials that are cheaper and more accessible. Unlike other chemistries, LFP batteries use resources that are everywhere on the planet. They do not require rare and expensive materials like nickel and cobalt that drive the cost of other cell types upward. LFP cells are also less likely to have runaway heat generation when damaged and therefore reduce the probability of a fire.

There are strong signals that LFP prismatic cells are emerging. In Asia, EV manufacturers already use LiFePO4 batteries, a type of LFP battery in the prismatic format. Tesla also stated that it has begun using prismatic batteries manufactured in China for the standard range versions of its cars.

The LFP chemistry has important downsides, however. For one, it contains less energy than other chemistries currently in use and, as such, can’t be used for high-performance vehicles like Formula 1 electric cars. In addition, battery management systems (BMS) have a hard time predicting the battery’s charge level.

The average electric car kWh per 100 miles (kWh/100 mi) is 34.6. This works out as 0.346 kWh per mile. In other words, on average, electric cars consume 34.6 kWh to travel 100 miles and 0.346 kWh to travel 1 mile.

Charging drop off boxes or trailers may be implemented in the mobile vehicle charger or delivery system.

The mobile charging station may include a clean energy harvester attachment to the roof of transport vehicle 12 for consistently charging the battery to preserve on fuel to power a generator and charge an electric vehicle, the clean energy harvester able to harvest energy from wind passing over the vehicle during driving or the sun.

The mobile charging station 10 may include a remote command center 60 shown in FIG. Fig, 2 capable of receiving communication from a consumer and remotely initiating a service call to the consumer. The mobile charging station 10 includes an automatic battery health and safety check system which may be incorporated in control panel 22 and ensures the battery is not leaking, or over heated to prevent vehicle fire. The mobile charging station may include an automated generator shut off which may be incorporated in control panel 22 and is implemented to prevent overload. The mobile charging station may include a temperature monitoring and control system for warning driver of battery issue and may be incorporated in control panel 22. The mobile charging station may include a perks program to earn wattage of charge for your vehicle if the service is used via the smart phone app on wireless device 24. The app may have the ability to automatically schedule consecutive charges to the vehicle with auto-pays. The mobile charging station may include a payment program to 3rd party operators, which pays an operator to go to a home and charge a vehicle via the smart phone app wherein the operator is paid on a per charge or time taken to charge basis with the equipment.

In some embodiments the method or methods described above may be executed or carried out by a computing system including a tangible computer-readable storage medium, also described herein as a storage machine, which holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A mobile charging station for a high voltage electric vehicle comprising:
a mobile vehicle for transporting charging apparatus, the charging apparatus including:
an electric energy source for providing electricity;
a circuit for converting the energy source electricity to a specific voltage range required by the electric vehicle to be charged; and
at least one connector engageable with a charging connector on the electric vehicle to be charged;
wherein the mobile charging station may be driven to the location of the electric vehicle.

2. The mobile charging station of claim 1 wherein a vehicle charge may be initiated by a communication sent from a cellular device or a mobile communication device.

3. The mobile charging station of claim 1 including a remote command center capable of receiving communication from a consumer and remotely initiating a service call to the consumer.

4. The mobile charging station of claim 1 including an automatic battery health and safety check system to ensure the battery is not leaking, or over heated to prevent vehicle fire.

5. The mobile charging station of claim 1 including an automated generator shut off to prevent overload.

6. The mobile charging station of claim 1 including a temperature monitoring and control system for warning driver of battery issue.

7. A mobile electric vehicle charging network including a plurality of mobile charging stations of claim 1, the mobile electric vehicle charging network comprising;
a command center capable of carrying out any of the following steps including:
receiving and sending communication requesting charging service; locating a customer vehicle requiring a charge;
sending a communication to at least one of the mobile charging stations including information on the customer vehicle location;
if needed, providing a signal for unlocking customer vehicle;
taking orders from a mobile app and if needed, communicating the information to at least one of the mobile charging stations; and
ensuring payment has been made.

8. A method of using a mobile electric vehicle charging network comprising:
providing a plurality of mobile charging stations according to claim 1;
providing a command center in communication with the plurality of mobile charging stations;
receiving a communication requesting charging
service; locating a vehicle requiring a charge;
calculating which mobile charging station to send to a customer
requesting service or for a customer having a scheduled charge;
sending a communication to the mobile charging station chosen in the previous step, including information on the electric vehicle location;
if needed, providing a signal for unlocking the electric vehicle;
and charging the electric vehicle.

9. A method of using a mobile electric vehicle charging station comprising:
providing a mobile charging station according to claim 1;
receiving a communication requesting charging
service; locating a vehicle requiring a charge;
if needed, providing a signal for unlocking the electric vehicle;
and charging the electric vehicle.

10. The mobile charging station according to claim 1 including a perks program to earn wattage of charge for your vehicle if the service is used via the smart phone app the program including the ability to automatically schedule consecutive charges to the vehicle with auto-pays.

11. The mobile charging station according to claim 1 including a payment program to 3rd party operators, which pays an operator to go to a home and charge a vehicle via the smart phone app. The operator is paid on a per charge or time taken to charge basis with the equipment.

12. The mobile charging station according to claim 1 including a clean energy harvester attachment to the roof of a transport vehicle for consistently charging the battery to preserve on fuel to power a generator and charge an electric vehicle, the clean energy harvester able to harvest energy from wind passing over the vehicle during driving or the sun.

13. A remote charging device for an electric vehicle comprising:
a separate vehicle;
said separate vehicle comprising an electrical generator, a motor mechanically coupled to said electrical generator to operate said generator to produce an electric charge;
a fuel tank fluidly connected to said motor;
a charging distribution device electrically connected to said generator; and
a state of charge indicator connected to said charging distribution device.

14. The method of using said remote charging device of claim 13 wherein a user connects said electric vehicle to said charging distribution device and said user starts said motor and said generator to produces an electric charge that charges said electric vehicle; and said user stops said motor when said state of charge indicates the desired level of charge.

15. The mobile charging station according to claim 1 including a perks program to earn wattage of charge for your vehicle if the service is used via a smart phone app.

16. The mobile charging station according to claim 15 wherein the app has the ability to automatically schedule consecutive charges to the vehicle with auto-pays.

17. The mobile charging station according to claim 1 including an automatic battery health and safety check system to ensure the battery is not leaking, or over heated to prevent vehicle fire.

18. The mobile charging station according to claim 1 including an automated generator shut off to prevent overload.

19. The mobile charging station according to claim 1 including a payment program to 3rd party operators, which pays an operator to go to a home and charge a vehicle via the smart phone app wherein the operator is paid on a per charge or time taken to charge basis with the equipment.
